(19) United States
(12) Patent Application Publication
(10) Pub. No.: US 2015/0059308 A1
(43) Pub. Date: Mar. 5, 2015

(54) COMBINED DEVICE FOR WINDROWING AND FOR PRESSING INTO BALES, PARTICULARLY FOR HAY

(71) Applicant: Jean-Michel ROUX, LIMOGES (FR)

(72) Inventor: Jean-Michel ROUX, LIMOGES (FR)

(73) Assignee: KAMF, FLAVIGNAC (FR)

(21) Appl. No.: 14/474,525

(22) Filed: Sep. 2, 2014

(30) Foreign Application Priority Data
Sep. 3, 2013 (FR) 13 58397

(51) Int. Cl. A01D 39/00; A01D 57/28; A01D 84/00

(52) U.S. Cl. CPC A01D 39/00; A01D 84/00; A01D 57/28
USPC 56/15.7

(57) ABSTRACT

A combined device for windrowing and for baling by pressing, particularly of hay, intended to be connected to a tractor equipped with a three-point hitch and with a power takeoff, includes hitching elements (10), a single frame (12) on wheels (54-1, 54-2) including windrowing elements (14) and elements (16) for receiving and supporting a baler (18). The device also includes a second variant.

This invention relates to a combined device for windrowing and for baling by pressing, particularly of hay, on an agricultural property.

Farm operators, owners or contractors, have to reduce personnel for obvious reasons of cost, of recruitment, of flexibility of the work.

Mechanization has made it possible to limit operations and advances have led to savings in work time with various tools so that the margin of savings in time on an operation still remains possible but proportionally, this margin of savings can only be modest.

Furthermore, for considerations linked to the quality of the desired products, it is necessary to be extremely reactive. If personnel are limited in number, it is therefore not possible to resort to an army of operators to intervene.

Mutual help is difficult because all of the farm operators in the same sector wish to operate in the same way on the same crops and therefore generally at the same time. An operation using several machines and therefore several operators simultaneously to profit from a weather window is totally to be ruled out or is possible in a minute number of cases.

The operators have invested in equipment as indicated above, there is no question, but these investments are heavy and they have to be repaid. Proposing new equipment is one solution, but it is still necessary to pay off the previous equipment or to have the means to invest totally in a new piece of equipment and to under-utilize or waste the equipment of the existing stock.

A solution to gain in effectiveness, in yield, in cost, in personnel, in quality is to combine the operations, i.e., to perform operations concurrently.

This is what the device of this invention proposes doing, the two operations concerned being the windrowing and the baling of the hay, straw, for example.

For the following description, as an example the making of bales of hay is retained. When the farm operator wishes to prepare hay for its preservation to feed livestock in the winter or to market it, there are several successive operations.

The first is the cutting of the standing grass, namely the mowing.

The grass thus cut is dried in the open air, on the ground, and to facilitate this drying and to dry the material in its entirety, the grass is regularly turned over, this dried grass taking the name hay.

The enemy of the preservation of hay is moisture.

Also, when the hay is dry, it is good to store it. To limit volumes, the hay is compressed in the form of bales, which also makes it possible to store it in fractionated form and which also facilitates handling.

These bales can have a parallelepiped or round shape; in this case, the embodiment that will be concerned by this invention relates to a baler, particularly of round bales, that is to say having a cylindrical geometric shape, obtained by winding.

Before this baling operation, since the hay is scattered over the ground, it is necessary to gather it together to form columns of hay known as windrows, using a device that is rightly called a windrower, which makes it possible to feed the baler when it passes.

The mowing step constitutes the first operation, and it can only be performed alone.

The following step or steps of turning over are necessary and here again they can be performed only in an isolated manner, generally as a function of the weather conditions, and it is not possible to combine this turning-over step or these turning-over steps with another operation.

On the other hand, once dried, the operations of windrowing and pressing for baling can be combined.

That is the object of this invention.

A device exists, object of the French patent application No. 2 769 462, that describes a machine for harvesting farm products of the fodder type.

This arrangement successively comprises windrowing means, a collector and a traveling baler.

Thus, this arrangement must be adapted to the baler concerned in the case of the single frame hitch. The variant described that concerns the double hinge must be excluded for legal reasons.

It is noted consequently that the collector, which is generally incorporated into the baler, is provided independently in this prior art, which greatly complicates the arrangement.

Therefore, it involves an integral machine requiring a purchase of the complete machine.

The advantages that are going to be derived from the following description of a particular embodiment of this invention are numerous.

First of all, it clearly involves the performing of two operations in a single pass over the farm surface concerned.

Then, the device is perfectly suited because it makes it possible to use different types of balers and therefore to change the baler, which is particularly advantageous for contractors who can use at each farmer's place the baler that he has that delivers bales as the farmer desires with the expected quality.

For the owner, the advantage is also to be able to use the baler that he already has. This is actually a heavy investment that can therefore continue to pay off.

If the owner of the device according to this invention wishes to change balers, he can do it without any problem and can use the new baler instead of the previous one.

If the owner sees his baler break down, he can rent another baler, for example, and continue his baling work.

It is also noted that the size of the device allows it to travel on the road without exceeding the authorized road clearances, which is also a significant asset, especially for contractors who move over relatively long distances as will be explained farther on.

The device can be hitched to any farm machine provided with a power takeoff and with a three-point hitch because an interface plate is provided.

It is also noted that the device is rigid and does not constitute two trailers hitched to one another behind a tractor such as a train.

The hitching is easy, requiring the operator to make the hydraulic fluid connections, the electric connections, the mechanical connections, in a known way.

The device according to this invention is now described in detail with regard to the accompanying drawings, without this embodiment being considered as limiting, drawings in which the different figures show:

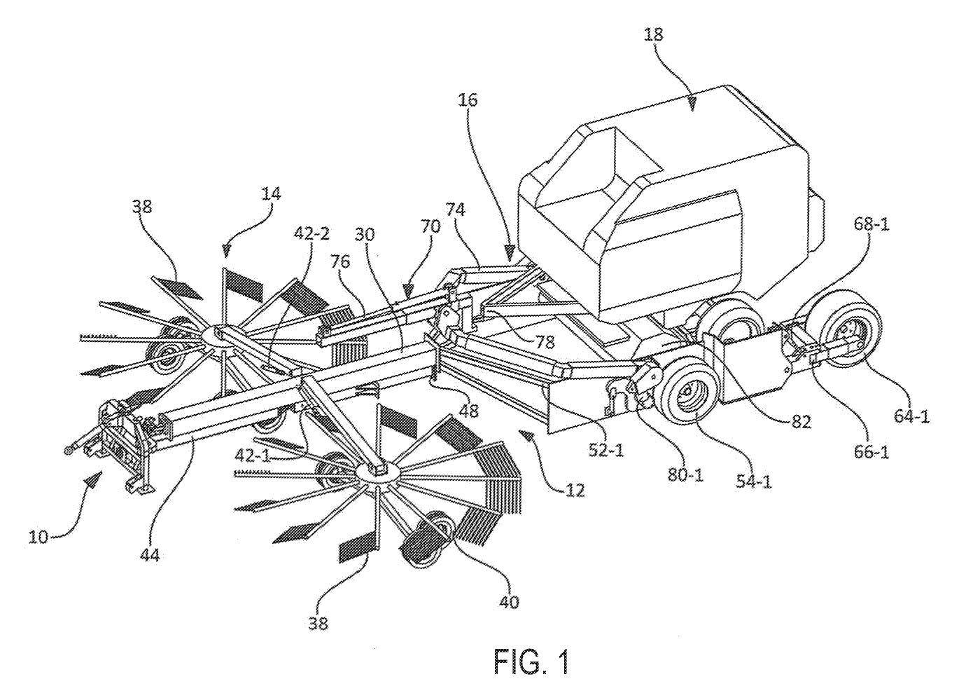

FIG. 1: a perspective view of the device according to this invention, operational, ready to be hitched with the baler,

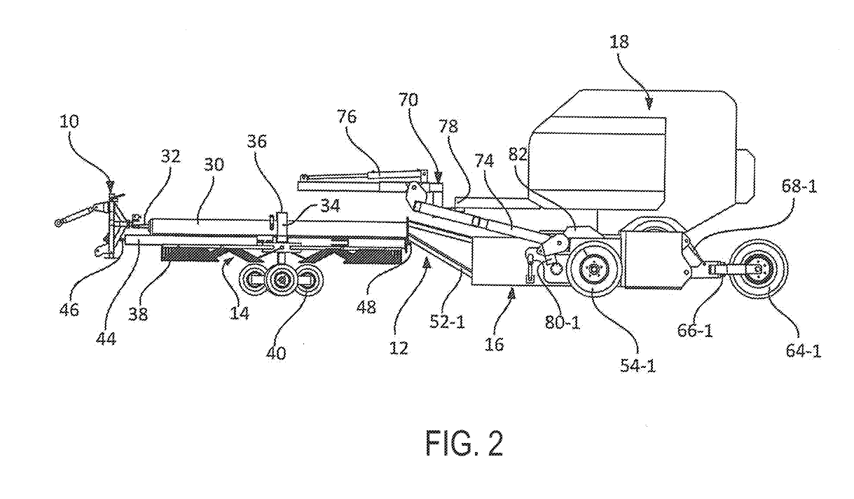

FIG. 2: a lateral elevation view of the device of FIG. 1,

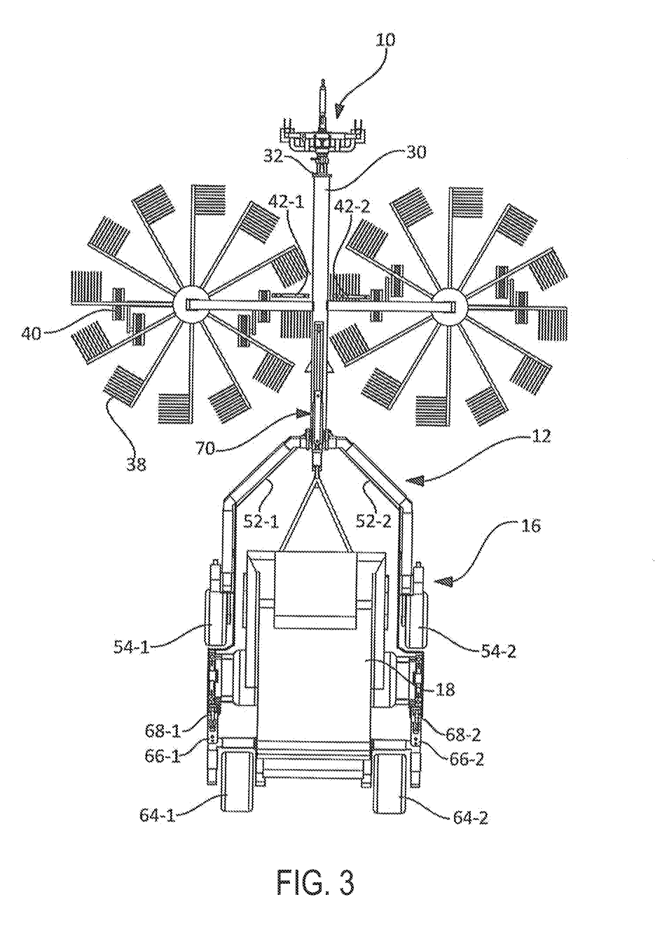

FIG. 3: a top view of the device of FIG. 1,

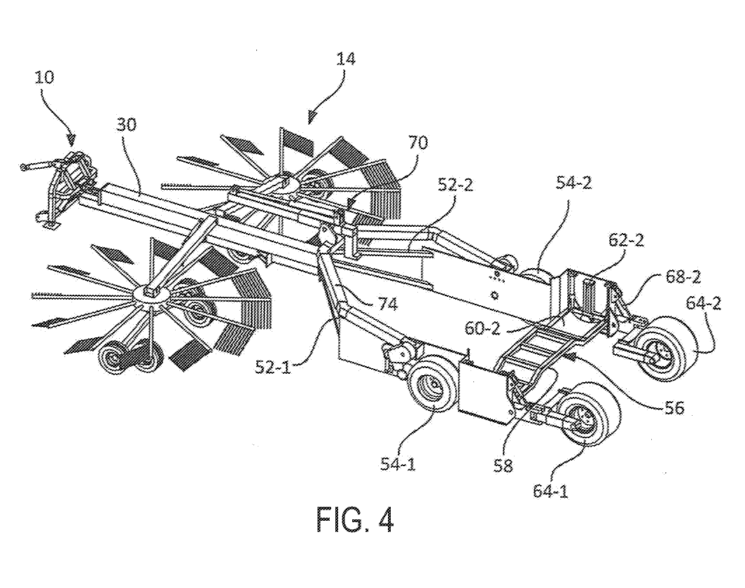

FIG. 4: a perspective view of the device according to this invention, operational, ready to be hitched without the baler,

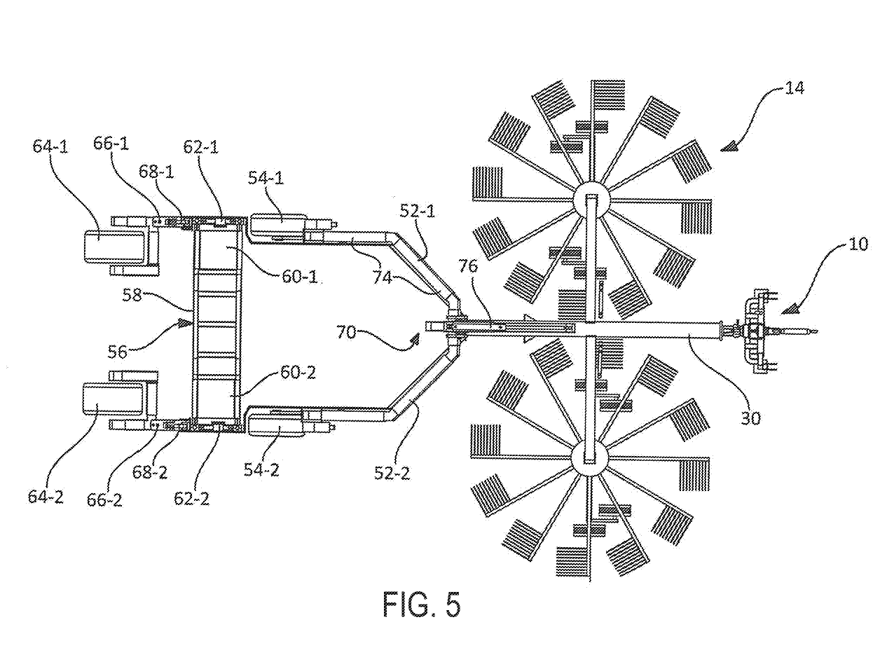

FIG. 5: a top view of the device of FIG. 4,

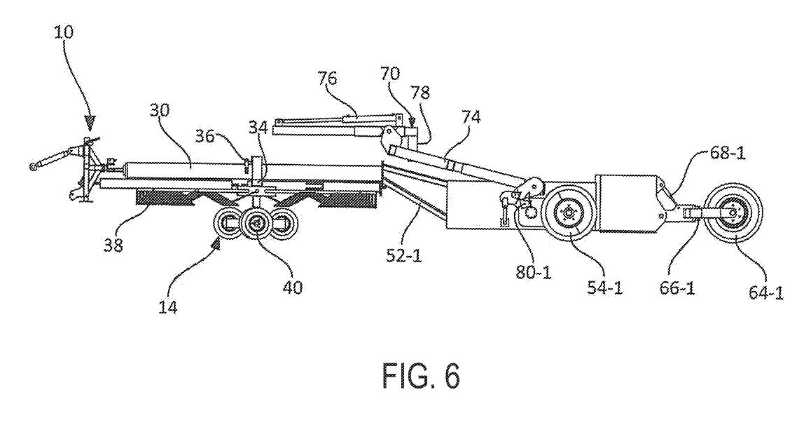

FIG. 6: a lateral elevation view of the device of FIG. 4,

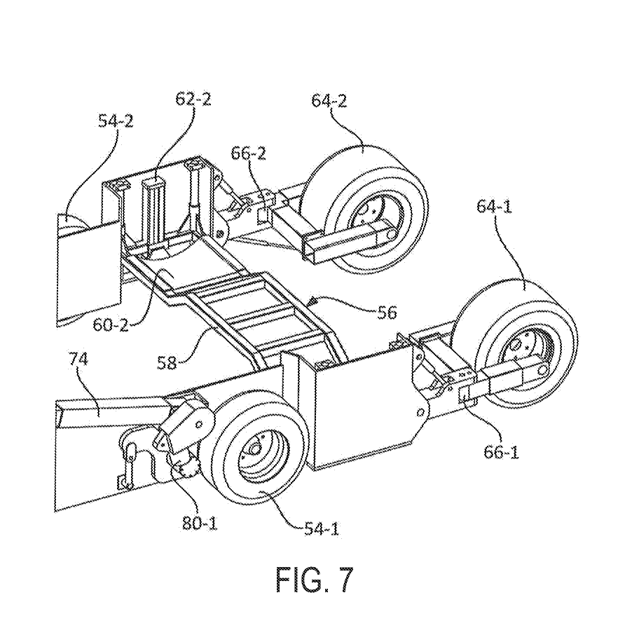

FIG. 7: a detail view of the positioning means of the baler,

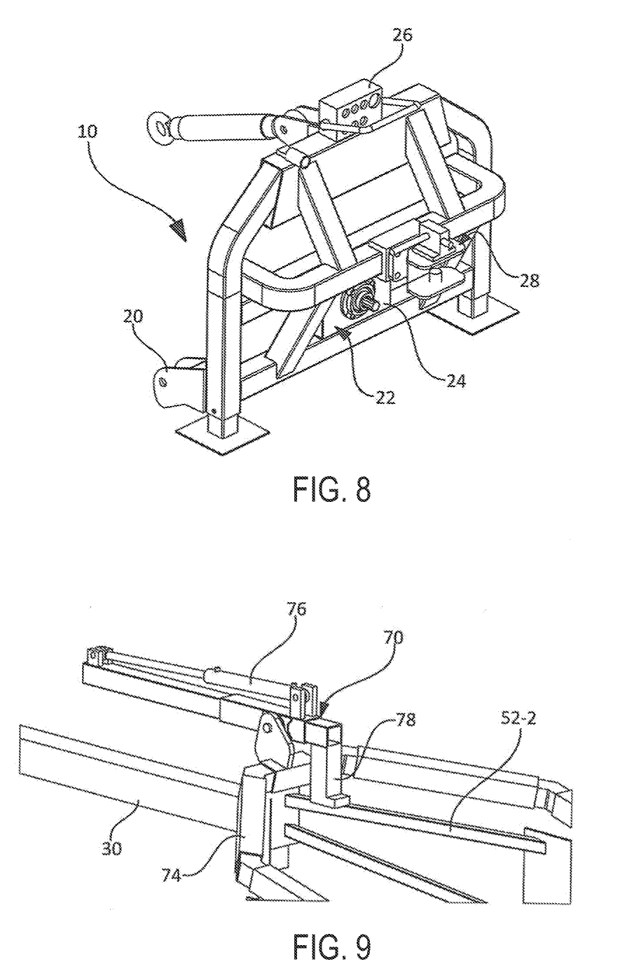

FIG. 8: a detail view of the hitching means,

FIG. 9: a detail view of the means for loading the baler,

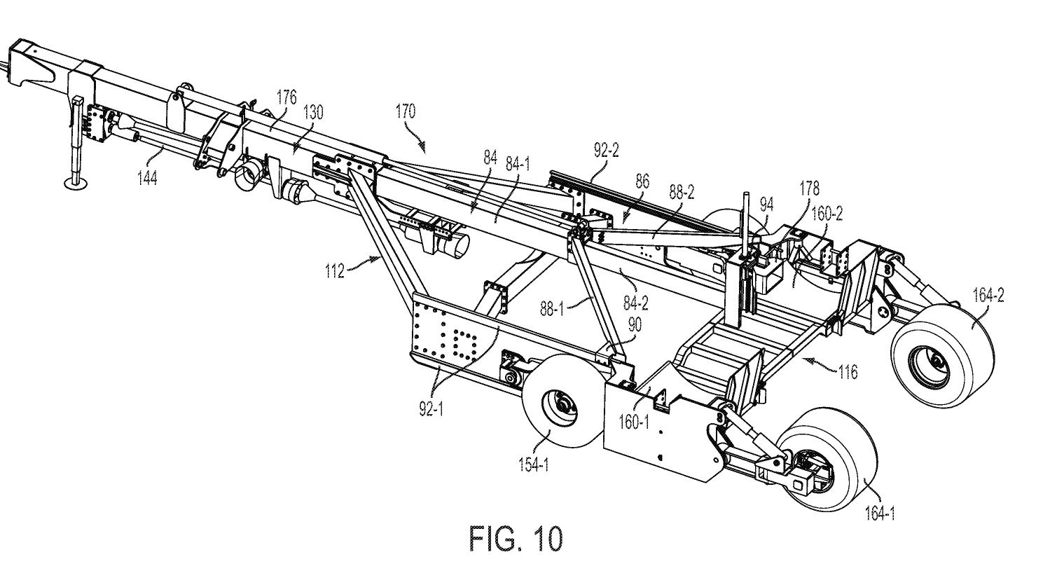

FIGS. 10: a perspective view of a variant of the device according to this invention, more particularly of the device for loading and for holding the baler in rolling position, the windrowing means having been withdrawn for clarity of the figure,

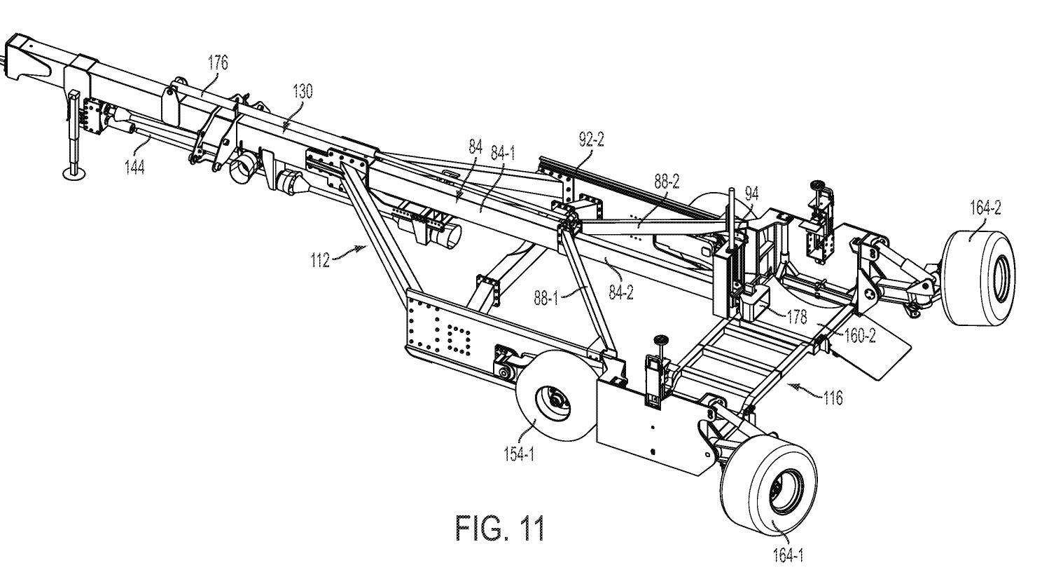

FIG. 11: a perspective view of the device according to FIG. 10, in loading position,

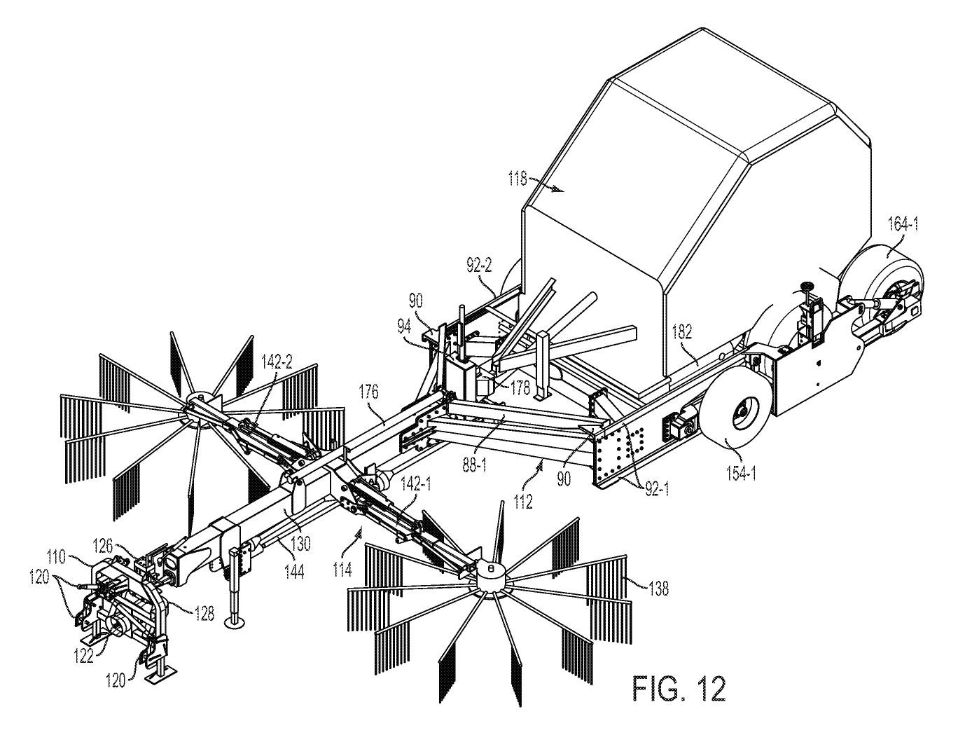

FIG. 12: a perspective view of the variant of the device of FIG. 10, once the baler is loaded,

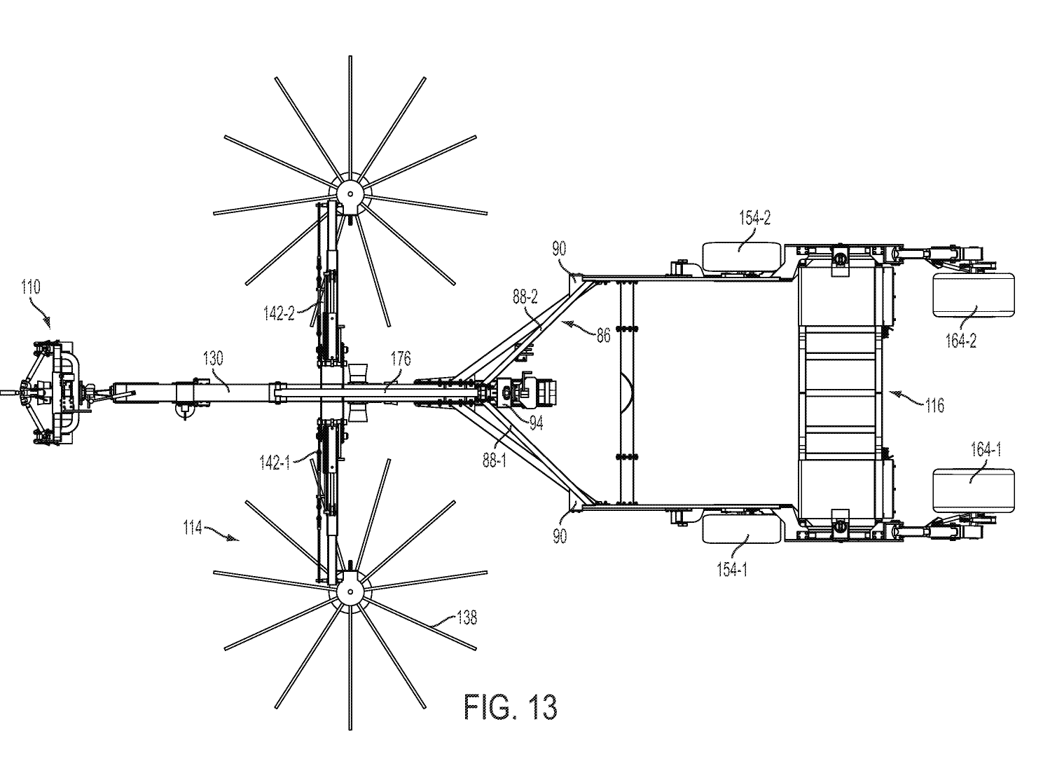

FIG. 13: a top view of the complete device, according to the variant of FIG. 10, without the baler, with the windrowing means in work position,

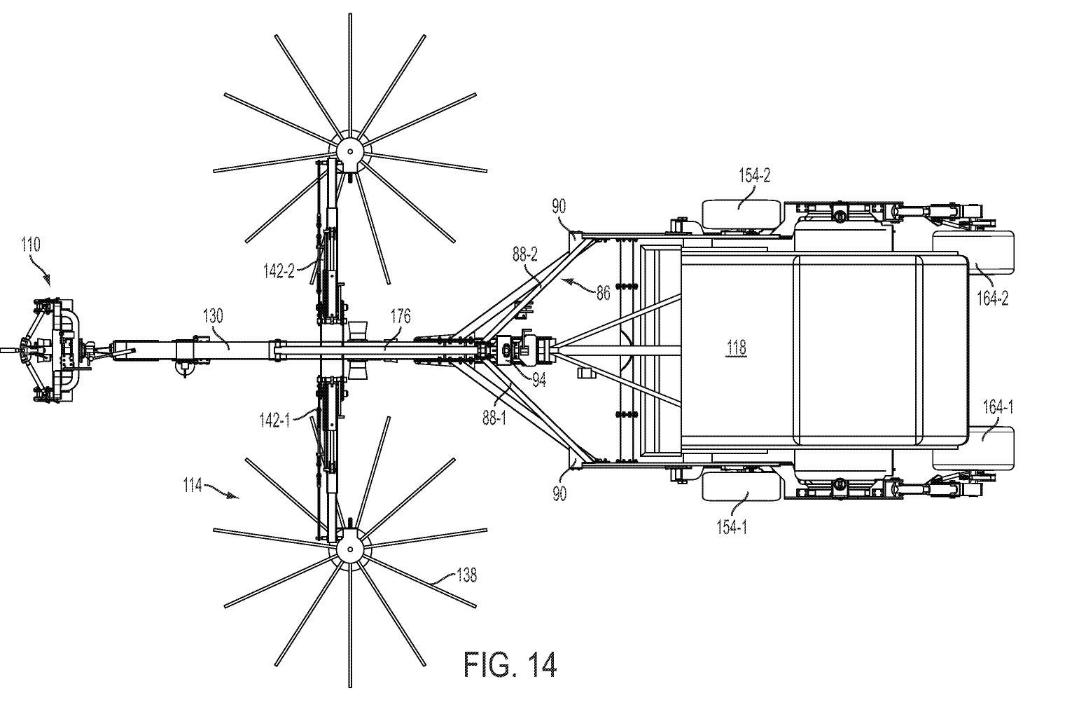

FIG. 14: a view of the baler of FIG. 13 but with the baler in place,

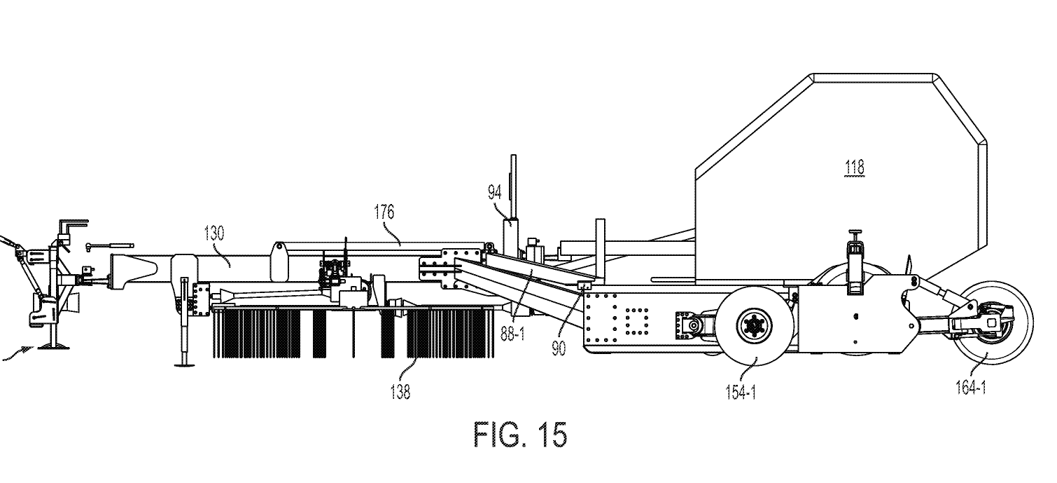

FIG. 15: a lateral elevation view of the complete device according to the variant of FIG. 10, in combined work position.

This invention is now described in detail in accordance with a first embodiment.

The device concerned comprises hitching means 10, a single frame 12, windrowing means 14 and means 16 for receiving and support of a baler 18 as can be seen in FIGS. 1, 2 and 3.

The hitching means 10, shown in detail in FIG. 8, comprise a three-point mechanical interface 20, intended to work with the three-point hitch of the tractor, not shown.

These hitching means 10 further comprise a driving interface 22 intended to work with the power takeoff of the tractor, not shown, to supply the mechanical power and the hydraulic power and to transmit them to the driven mobile elements of the windrower and of the baler.

The mechanical interface 20 can also support means 24 for controlling the rotation speeds.

On the mechanical interface of these hitching means 10, fluid connections 26 are also found in a known way to ensure the distribution of energy through the hydraulic fluid to the components requiring a hydraulic transmission, as shown in FIG. 8.

Finally, the mechanical interface 20 comprises a hitching plate 28, in this case an automatic key yoke, particularly to receive the single frame 12.

The single frame 12, see FIGS. 1 to 9 as a whole, comprises a tongue 30 and receiving and support means 16 intended to accommodate a baler 18.

The tongue 30 is equipped with a ring 32 intended to work with the hitching plate 28 of the hitching means 10, by its upstream end if the direction of movement of the unit toward the front is considered.

The other end of the tongue 30 is integral with receiving and support means 16 intended to accommodate a baler 18.

The tongue 30 also supports the windrowing means 14 that are therefore placed upstream from the receiving and support means 16 intended to accommodate the baler 18.

These windrowing means 14 comprise two arms 34-1 and 34-2 that are mobile relative to said tongue so as to be able to impart to them two positions, one for transport in which the arms are lifted up vertically in a rotational movement upward and the other for work in which the arms are approximately horizontal.

These arms 34 are moved by any suitable means, and in the preferred embodiment, which is known and simple, the arms 34 are moved by hydraulic cylinders 36.

Each arm 34 carries rakes 38 mounted so they can rotate as well as a wheel set 40 intended to roll on the ground to maintain the height of the rakes in relation to the ground, with these wheels forming a gauge wheel set.

To drive the rakes in rotation, a mechanical drive system by shafts 42-1 and 42-2 is provided.

Also, in a known way, a main shaft 44 is carried by the tongue 30 with an upstream connection 46, able to work with the drive interface 22.

This main shaft 44 extends up to the rear of said tongue 30 with a downstream connection 48.

Advantageously, and to adjust the speeds of rotation, a reducing gear 50 can be positioned on this main shaft 44 in the direction of the two shafts 42-1 and 42-2.

The receiving and support means 16 intended to accommodate a baler 18 are now described in detail with regard to FIGS. 4, 5, 6, and 7, in which the baler 18 has been eliminated to facilitate the reading, in addition to FIGS. 1, 2 and 3 in which the baler is in position, the references being identical.

The single frame 12 therefore comprises the tongue 30 that is extended by the receiving and support means 16 of the baler 18.

These receiving and support means 16 comprise two beams 52-1 and 52-2, each carrying a bearing wheel 54-1 and 54-2 with its suspension means. These beams 52 approximately form a Y with the tongue 30. The distance between the branches of the Y that is formed from the beams is road-width size.

These two beams 52 are connected at their rear ends by a cradle 56, which is therefore found in crosswise position.

This cradle 56 carries, on both sides of a bridge 58, two buckets 60-1 and 60-2 intended to receive the wheels of the baler 18 as will be further explained.

This cradle 56 is carried by hoists 62-1 and 62-2. These hoists 62 are advantageously of the hydraulic cylinder type for the homogeneity of the arrangement.

These hoists 62 therefore make it possible to place the cradle 56 in several positions, including at least one first low position P1 for positioning the baler 18 and a second raised position P2 for movement, for example on the road. In addition, in the absence of a baler, the cradle can be raised into the second position to make it possible to pass over a windrow that has just been formed upstream by the rakes 38.

The receiving and support means 16 of the baler 18 are completed by gauge wheels 64-1 and 64-2.

These wheels 64 are directional around a vertical pin 66-1 and 66-2 in work position controlled by any means such as hydraulic cylinders. In an extreme configuration, they can therefore be pivoted to the outside during the introduction of the baler 18 as will be explained further. Also, the support of wheels is equipped with directional and raising elements 68-1 and 68-2, in this case cylinders.

These raising elements also make it possible, if necessary, to adjust the work height so as to position the cradle 56 at the proper height relative to the ground and therefore to position in relation to the ground the baler 18 that it supports when it is in work position.

The receiving and support means 16 of the baler 18 in addition comprise means 70 for loading and for holding the baler 18.

In the first embodiment shown, these loading and holding means 70 comprise a loading pole 72 mounted in rotation and in translation facing the junction point of the tongue and the beams, on an arch 74.

A maneuvering element 76, in the form of a hydraulic cylinder, still in the interest of homogeneity, allows these maneuvers of the loading pole 72.

At its free end, this pole 72 carries means 78 for removable connection with the baler 18 so as to be able to ensure its pulling onto and its holding on the cradle 56.

This pole is mounted on an arch 74 that is mounted to pivot approximately facing the wheels 54 and maneuvered by maneuvering elements 80-1 and 80-2, can assume a downstream position to hook the baler, and can pivot to assume an upstream position under the pulling effect of the maneuvering element 76, because of the geometry of the arch 74 and of the pole 72.

Likewise, the main drive shaft 44 ensures the transmission of power necessary for the baler 18. Each commercial baler 18 is equipped with its own drive shaft (not shown) in a standardized manner, this shaft being able to be connected with a power takeoff of a machine, in this case with the downstream connection 48 of said main shaft that ensures the transfer of power.

The combined device, as has just been described, is used in the following way.

The operator drives the device that comprises the tongue and the windrower, which is fixedly mounted, near the baler for use, for example.

The gauge wheels are raised and separated to allow the wheel set of the baler 18 to pass, the device being supported on its main wheels 54.

The operator lowers the cradle 56 to the ground and connects the pole 72 by its free end to the removable connection means of the baler 18 so as to be able to ensure its being pulled after having caused the arch 74 to pivot. Pivoting ramps can be added if necessary, not shown because they are within the grasp of a person skilled in the art.

The actuation of the maneuvering element 76 of the pole 72 makes it possible to pull the baler and to drive it until its wheels fit into the buckets 60-1 and 60-2 provided for this purpose, as a function of the different baler lengths and of their own tongues.

The gauge wheels 64 are brought back into position aligned with the road-width size. They will rest on the ground when the device will be in work position.

The different mechanical connections are made since the device has already been connected to the tractor because it is necessary to have electricity and hydraulic power for these first maneuvers.

Thus, the windrowing means 14 can be driven at the suitable speed of rotation, for a given speed of rotation of the power takeoff of the tractor.

Likewise, the drive shaft of the baler 18 is driven by the main shaft 44 at the recommended speed of rotation to make the bales, for a given speed of rotation of the power takeoff of the tractor. This output speed is defined for the windrowing means as it is for the baler by the manufacturer.

Generally, the output speed of the mechanical interface is suited to the baler and, in light of this speed, the speed of rotation of the rakes of the windrowing means 14 is adapted, since a reducing gear can be positioned as indicated above in the description.

The combined device is brought to the space to be worked.

The operator places the device in work configuration. To achieve this, he lowers the arms 34 that support the rakes 38, and the wheel sets 40 make contact with the ground.

Concerning the baler, the gauge wheels 64 are lowered in contact with the ground in the direction of movement. The work height is adjusted as a function of the weight and geometry of the baler.

The baler 18 finds itself in a configuration such that the pickup 82 is in the work configuration both in height and in inclination.

The field to be worked is covered with dry hay.

When the operator advances in the field, the pulled device ensures, thanks to the windrowing means 14, the gathering of the hay that is found on the working width of the rakes in the form of a windrow centered on the axis of movement of the pulled device.

The hay windrow is swallowed by the pickup and processed by the baler 18 so as to make bales that are generally released into the field.

The device is now described with regard to FIGS. 10 to 15 according to a variant embodiment of the loading and holding means 70 of the baler 18.

The references for this second embodiment will be identical to those of the first embodiment for the identical elements, increased by 100.

The frame 112 remains approximately identical, with a tongue 130, receiving and support means 116 intended to accommodate a baler 118.

The loading and holding means 170 of this second embodiment are modified. These loading and holding means 170 comprise a telescopic arm 84 arranged in the tongue 130 that forms a sleeve and moved by a maneuvering element 176.

This telescopic arm 84 is equipped with means 178 for removable connection with the baler so as to be able to ensure the pulling into and the holding of said baler 118 in the buckets 160-1 and 160-2.

This telescopic arm 84 comprises two mobile elements 84-1 and 84-2.

The free end of the first element 84-1 is integral with stiffening means 86. These stiffening means 86 comprise two struts 88-1 and 88-2 placed in a V-shape. One of the ends of each of the two struts 88-1 and 88-2 is secured to the end of the first element, and the other end of each of the two struts 88-1 and 88-2 is equipped with slide runners 90. These slide runners 90 each work with a slide rail, 92-1 and 92-2 respectively, carried by the frame 112, more particularly by the sidewalls of said frame.

Thus, when the first element 84-1 is moved in translation, the two struts 88-1 and 88-2, which are solid with it, are simultaneously moved, the runners 90 each sliding in relation to the slide rails 92-1 and 92-2. The telescopic arm 84 is thus guided laterally and supported in height.

The element 84-2 is equipped with means 178 for removable connection with the baler so as to be able to ensure the pulling and the holding of said baler 118 in the buckets 160-1 and 160-2 and also comprises means 94 for adjusting the height of these connection means 178. Such adjustment means 94 can take the form of a hydraulic cylinder arranged vertically, therefore perpendicular to the element 84-2 that supports it.

It is thus possible, once the baler 118 is loaded, to adjust the inclination of the tongue of the baler, which increases or reduces the height of the pickup 182 relative to the ground in particular.

In addition, this supplementary adjustment makes possible an improved adaptation to the various models of balers and an adjustment as a function of the work.

It is found therefore that the problems raised by this invention are solved, the first being windrowing simultaneously with baling.

In addition, the device according to the invention, according to one or the other of the embodiments, makes it possible to use any baler at any time.

It is noted that the problem of the double hitching that violates regulations has disappeared and that the road-width size is nevertheless complied with.

The baler used requires no modification or adaptation to be suitable for the device according to this invention.

The work speeds of each of the windrowing and baling means are complied with, because the speeds from the same power source—that of the power takeoff of the tractor—can be different.

The device is very flexible because it can allow a use of the windrower without a baler if necessary.

The interface is also provided to receive other machines having a standard hitching system and not a three-point hitch. Then, all that needs to be done is to leave this interface hitched and to unhook the device according to this invention.

The device according to the invention can thus ensure four different types of work for the same owner:
Windrowing
Using his baler
Using another baler
Windrowing and baling at the same time.

In addition, for a contractor, the device makes it possible for him to go to a farmer customer's place and to use the baler of said customer farmer to produce bales as desired by the customer and made by his baler.

If the baler of the farmer has broken down, the contractor can resort to another of the balers of said farmer, he can borrow that of a neighbor, or he can also rent a baler, to perform the work, thanks to the device according to this invention.

1. Combined device for windrowing and for baling by pressing, particularly of hay, intended to be connected to a tractor equipped with a three-point hitch and with a power takeoff, characterized in that it comprises hitching means (10, 110), a single frame (12, 112) on wheels (54-1, 54-2; 154-1, 154-2) comprising windrowing means (14, 114) and means (16, 116) for receiving and supporting a baler (18, 118).

2. Combined device for windrowing and for baling by pressing according to claim 1, wherein the hitching means (10, 110) comprise a mechanical three-point interface (20, 120), intended to work with the three-point hitch of the tractor, and a driving interface (22, 122), intended to work with the power takeoff of said tractor.

3. Combined device for windrowing and for baling by pressing according to claim 2, wherein the mechanical interface (20) supports means (24) for controlling the rotation speeds.

4. Combined device for windrowing and for baling by pressing according to claim 2, wherein the mechanical interface (20, 120) comprises a hitching plate (28, 128).

5. Combined device for windrowing and for baling by pressing according to claim 1, wherein the single frame (12, 112) comprises a tongue (30, 130) equipped with a ring (32, 132) intended to work with the hitching means (10, 110) by its upstream end and extending to form the receiving and support means (16, 116) that are intended to accommodate the baler (18, 118) at the other end.

6. Combined device for windrowing and for baling by pressing according to claim 5, wherein the tongue (30, 130) supports the windrowing means (14, 114).

7. Combined device for windrowing and for baling by pressing according to claim 6, wherein the windrowing means (14, 114) comprise two arms (34-1, 34-2; 134-1, 134-2) that are mobile in relation to the tongue (30, 130) and that are placed upstream from the receiving and support means (16, 116) that are intended to accommodate the baler (18, 118), each arm carrying rakes (38, 138) mounted to rotate as well as a wheel set (40, 140).

8. Combined device for windrowing and for baling by pressing according to claim 6, wherein it comprises a mechanical drive system by shaft (42-1, 42-2; 142-1, 142-2) for driving the rakes (38, 138) in rotation.

9. Combined device for windrowing and for baling by pressing according to claim 1, wherein the means (16, 116) for receiving and supporting the baler (18, 118) comprise two beams (52-1, 52-2;
152-1, 152-2), each carrying a wheel (54-1, 54-2; 154-1, 154-2) with its suspension and rolling means and constituting approximately a Y, their rear ends being connected by a cradle (56, 156), itself comprising on both sides of a bridge (58, 158) two buckets (60-1, 60-2; 160-1, 160-2) that are intended to receive the wheels of the baler (18, 118).

10. Combined device for windrowing and for baling by pressing according to claim 9, wherein the cradle (56, 156) is carried by hoists (62-1, 62-2; 162-1,162-2) so as to place the cradle (56, 156) in at least a low first position P1 for positioning the baler (18, 118) and a raised second position P2 for moving.

11. Combined device for windrowing and for baling by pressing according to claim 10, wherein the receiving and support means (16, 116) of the baler (18, 118) comprise gauge wheels (64-1, 64-2; 164-1, 164-2) that are mounted in a directional manner around a vertical pin (66-1, 66-2; 166-1, 166-2) and equipped with raising elements (68-1, 68-2; 168-1, 168-2).

12. Combined device for windrowing and for baling by pressing according to claim 10, wherein the receiving and support means (16, 116) of the baler (18, 118) further comprise means (70, 170) for loading and for holding said baler (18, 118).

13. Combined device for windrowing and for baling by pressing according to claim 12, wherein these loading and holding means (70) of said baler (18) comprise a loading pole (72), mounted in rotation and in translation on an arch (74) equipped with a maneuvering element (76, 176).

14. Combined device for windrowing and for baling by pressing according to claim 12, wherein these loading and holding means (170) of said baler (118) comprise a telescopic arm (84), comprising at least one element (84-1, 84-2), arranged in the tongue (130) and moved by a maneuvering element (176) and stiffening means (86).

15. Combined device for windrowing and for baling by pressing according to claim 12, wherein these stiffening means (86) comprise two struts (88-1, 88-2) placed in a V-shape, one of the ends of each of the two struts (88-1, 88-2) being secured to the end of the first element and the other end of each of the two struts (88-1, 88-2) being equipped with slide runners (90) able to work by sliding with a slide rail (92-1, 92-2), carried by the single frame (112).

16. Combined device for windrowing and for baling by pressing according to claim 3, wherein the mechanical interface (20, 120) comprises a hitching plate (28, 128).

17. Combined device for windrowing and for baling by pressing according to claim 7, wherein it comprises a mechanical drive system by shaft (42-1, 42-2; 142-1, 142-2) for driving the rakes (38, 138) in rotation.

18. Combined device for windrowing and for baling by pressing according to claim 11, wherein the receiving and support means (16, 116) of the baler (18, 118) further comprise means (70, 170) for loading and for holding said baler (18, 118).
